(19) United States
(12) Patent Application Publication
(10) Pub. No.: US 2008/0164720 A1
(43) Pub. Date: Jul. 10, 2008

(54) EXTENDABLE ROOM-IN-ROOM FOR RECREATIONAL VEHICLES

(76) Inventor: Johnnie R. Crean, Ontario, CA (US)

Correspondence Address: MARC E. HANKIN, ESQ., 11414 THURSTON CIRCLE, LOS ANGELES, CA, 90049, US

(21) Appl. No.: 11/620,602

(22) Filed: Jan. 5, 2007

(51) Int. Cl. B60P 3/39

(52) U.S. Cl. 296/165

(57) ABSTRACT

This invention discloses an extendable room-in-room slide-out room for recreational vehicles, which allows a substantial increase in the usable living space of a recreational vehicle, occupies a relatively small amount of the slide-out is contracted, and provides a means for maintaining horizontal surfaces both while extended and contracted.

### FIELD OF INVENTION

This invention relates, generally, to extendable rooms for recreational vehicles; more particularly, to extendable rooms for recreational vehicles that include a plurality of extendable sections.

### BACKGROUND

The art of recreational vehicle design has developed numerous systems for extendable rooms and living space in recreational vehicles (RV's). These extendable rooms operate, generally, by allowing additional floor space when the vehicle is parked through a slide-out room that extends laterally from one of the walls of the RV. When the vehicle is in motion, the slide-out is contracted, and secured to the vehicle chassis. In this manner, RV designers have allowed greater living floor space in a vehicle that remains small enough to be easily driven on the public highways.

Full-height RV slide-outs have been developed, whose ceiling height is approximately the same as the height of the vehicle interior. These slide-outs offer the advantage that they may be walked through and otherwise operate as full extensions of the living space interior when the vehicle is parked. Also, half-height RV slideouts have been developed, wherein the ceiling height of the slide-out area is less than the ceiling height of the RV living space. These slide-outs offer certain cost advantages because they require less sophisticated mechanisms to operate and less materials allow for more cost-effective construction. Meanwhile, half-height slide-outs remain usable for areas such as desks, beds, tables, and other such areas where full ceiling height is not required.

An example of a half-height slide-out room is disclosed by U.S. Pat. No. 5,050,927 to Montanari. Montanari's patent discloses a means whereby a half-height slide-out room can be extended beyond the rear wall of a motorhome. Montanari, thus, discloses a mechanism that creates a larger living space that is suitable for beds, desks, and the like.

An example of a full-height slide-out room is disclosed by U.S. Pat. No. 5,983,576 to Hanser et al. Hanser's device comprises a extendable room with accordion type walls and ceilings. Because the room's ceiling height is approximately equal to that of the RV's floor space, the slide-out room may be walked through and is highly usable. Other examples of full-height slide-out rooms are disclosed by U.S. Pat. Nos. 6,402,216 and 6,637,804 to McManus et al. and Crean, respectively. Both patents disclose unique mechanisms for full-height slide-out rooms and offer the advantages discussed above.

The above mechanisms, however, are somewhat limited because, when retracted, the walls and ceiling of the slide-out must be moved into the interior space of the RV. Also, oftentimes desks and beds occupy space in the full-height rooms, which full ceiling height is not generally needed for such furniture space.

In order to address some of the above issues a series of mechanisms have been developed, which take advantage of telescoping techniques in order to increase living space. U.S. Pat. No. 3,888,539 to Niessner, for example, teaches a slide-out room for a van with a telescoping floor that adds to the van a self-contained kitchen unit. Niesser's device, however, fails to disclose a mechanism whereby a telescoping mechanism is used to increase the floor space of a recreational vehicle.

Another such expandable structure is disclosed by U.S. Pat. No. 4,603,643 to Couvrette. Couvrette's disclosure teaches an expandable security structure for use in housing automatic teller machines. While Couvrette's telescoping structure increases the working space of an automated teller machine structure, it fails to teach a mechanism that is usable for expanding the living space of an RV. Similarly, U.S. Pat. Nos. 6,067,756 and 6,772,563 to Frerichs et al. and Kuhn, respectively, disclose telescoping room structures. None of these structures, however, discloses a means for increasing the size of an RV interior through telescoping means.

U.S. Pat. No. 3,941,414 to Platt discloses an RV structure that combines a retractable ceiling with a half-height slide-out room mechanism. Platt's device, thus, allows the user to expand upon the ceiling height and floor space of the RV. Platt's disclosure, however, fails to teach a mechanism whereby a telescoping mechanism may be used to expand an RV's floor space.

U.S. Pat. No. 3,833,954 to Daughenbaugh et al., meanwhile, teaches a telescoping transportable shelter. Daughenbaugh's structure comprises a trailer mounted shelter that, when parked, may be extended by extending telescoping sections of the shelter. In this manner the size of the parked shelter is substantially larger than the size of the shelter while in trailer mode. Daughenbaugh, however, fails to disclose a telescoping structure that is compatible with slide-out mechanisms with RV's.

Thus, there remains a long-felt need in the art for a expandable room structure for RV's, which combines an expandable full-height slide-out room with an expandable half-height slide-out room.

### SUMMARY OF THE INVENTION

This invention is directed towards overcoming the above shortcomings by teaching an extendable room-in-room slide-out mechanism for recreational vehicles. The disclosed invention improves upon the prior art mechanisms discussed above by teaching a mechanism that combines the benefits of both the full-height and half-height slide-out mechanisms discussed above. That is, in one embodiment of the invention, one portion of the extendable room-in-room slide-out mechanism is a full-height slide-out, which may be walked through and features approximately the same ceiling height as the RV living space. Another portion of the room-in-room slide-out is half-height and, thus, suitable for desks, beds, tables, and similar such furniture spaces that do not require full ceiling heights. Thus, a novel slide-out mechanism is disclosed which allows a substantial increase in the usable living space of a recreational vehicle, occupies a relatively small amount of the slide-out is contracted, and provides a means for maintaining horizontal surfaces both while extended and contracted.

In one embodiment of the invention, the first portion of the room-in-room slide-out is a full-height slide-out room, which attaches to one of the walls of a recreational vehicle. Like most conventional slide-outs, when the room-in-room slide-out is contracted, the outside wall of the slide-out mechanism lies flush with the outside walls of the recreational vehicle, in order to create a weatherproof seal with the opening of the outside walls. When the room-in-room is extended, the floor of the full-height slide-out extends laterally outwards from the body of the RV. The ceiling height and floor height of the full-height section of the room-in-room slide-out are approximately equal to the respective heights of the living space with in the RV. Thus, when extended, the full-height section may be walked through and used in a similarly versatile manner as the rest of the RV living space.

In one embodiment of the invention, the second portion of the room-in-room slide-out is a half-height slide-out mechanism which is housed within the full-height slide-out mechanism. (It should be noted that, throughout this specification, “half-height” is used to denote a height less than the full-height slide-out, although not necessarily fifty-percent). The half-height slide-out mechanism is configured such that its floor height is higher than the floor height of the full-height section and its ceiling height is approximately equal to that of the full-height section. The width of the half-height section may be approximately equal to the full-height section or any width lower than that of the full-height section.

In this manner, the above combined slide-out rooms form a RV slide-out assembly wherein the fully extended slide-out includes a full-height section and a half-height section. The full-height section offers the versatility of conventional full-height slide-outs while the half-height section offers an economical means of including extendable space for desks, tables, beds, and the like. The room-in-room slide-out mechanism offers several advantages of prior arts systems because, while in a contracted position, the slide-out may remain a usable portion of the living space. In one embodiment of the invention, for example, a desk is included in the half-height section that is usable both when extended and when contracted. In another embodiment of the invention, a bed is included in the half-height section, which is similarly usable in both the extended and contracted position.

It should be noted that the principles of the invention may be practiced with any of the slide-out mechanisms, configurations, and materials known in the art. In one embodiment of the invention, for example, both the full-height and half-height sections are operated by electro-mechanical mechanisms that allow the room-in-room to be extended or contracted through switches accessed by the user. In one embodiment of the invention, the controls further allow the user to select whether or not to operate either or both of the slide-out mechanisms. In this manner, the slide-out mechanisms operate independently of one another. That is, either may be extended while the other is contracted or visa-versa.

The invention also may be practiced electro-hydraulic, hydraulic, electro-pneumatic, pneumatic, motor driven, manual, or any other of the mechanisms known in the art. The invention also may be practiced with conventional horizontal slide-out mechanisms or the tilt-out room mechanism disclosed in the U.S. patent application by Crean et al. Finally, the invention may be practiced with any metallic, non-metallic, plastic, reinforced plastic, fiberglass, reinforced fiberglass, fiber reinforced plastic, composites, other any other such materials known in the art for RV construction.

It should be noted that, in the interests of clarity, numerous details for the functionality of the room-in-room mechanism and variations on the configuration of the room-in-room are not included in this disclosure. Nevertheless, these details are known within the art and the variations remain within the contemplation of this invention.

In summary, the invention teaches a mechanism for an extendable room-in-room slide-out room for recreational vehicles, which allows a substantial increase in the usable living space of a recreational vehicle, occupies a relatively small amount of space when the slide-out is contracted, and provides a means for maintaining horizontal surfaces both while extended and contracted.

### BRIEF DESCRIPTION OF THE DRAWINGS

FIG. 1 is an illustration in perspective view of an RV featuring one embodiment of the invention in an extended position.

FIG. 2 is an illustration in cross-sectional view of an RV featuring one embodiment of the invention in an extended position.

FIG. 3 is an illustration in cross-sectional view of an RV featuring one embodiment of the invention in an extended position.

FIG. 4A is a floor-plan of an RV featuring one embodiment of the invention while contracted.

FIG. 4B is a floor-plan of an RV featuring one embodiment of the invention while extended.

FIG. 5 is an illustration in perspective view from the interior of an RV featuring one embodiment of the invention in an extended position.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope the invention.

In the following description, certain terminology is used to describe certain features of one or more embodiments of the invention. For instance, “recreational vehicle” refers to motorhomes, toy-box trailers, fifth wheel trailers, towable trailers, truck campers, folding trailers, van conversions, and other such vehicles known in the art; “slide-out” refers to any of the laterally or otherwise extending slide-out rooms known in the art; “half-height” refers to a slide-out of a ceiling height less than the ceiling height of the RV interior; and “window” refers to any transparent barrier or panel, including glass, plexiglass, acrylic, polyvinyl, and other such materials.

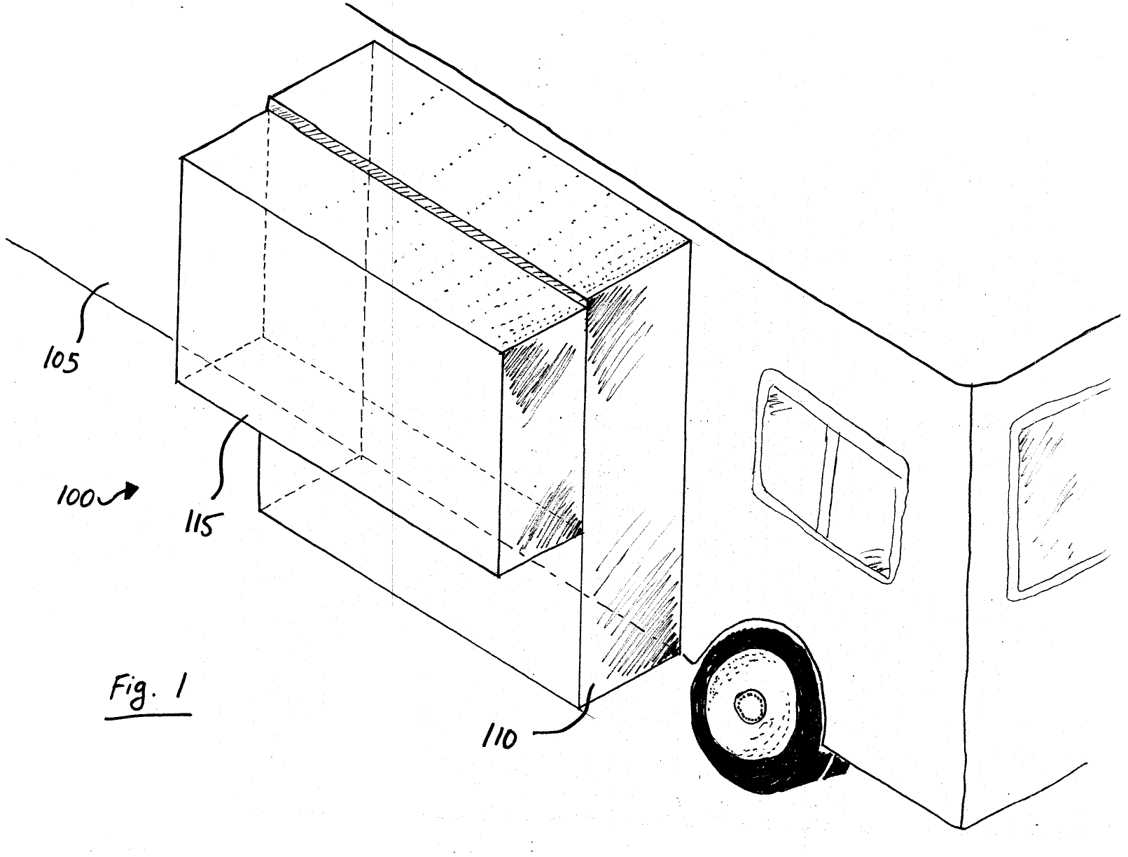

FIG. 1 is an illustration in perspective view of an RV featuring one embodiment of the invention in an extended position. A motorhome body 105 is shown featuring an extendable room-in-room slide-out 105. The room-in-room slide-out includes a full-height slide-out 110 and a half-height slide-out 115. The full-height slide-out 110 and a half-height slide-out 115 extend laterally outward from a side-wall of the motorhome body 105.

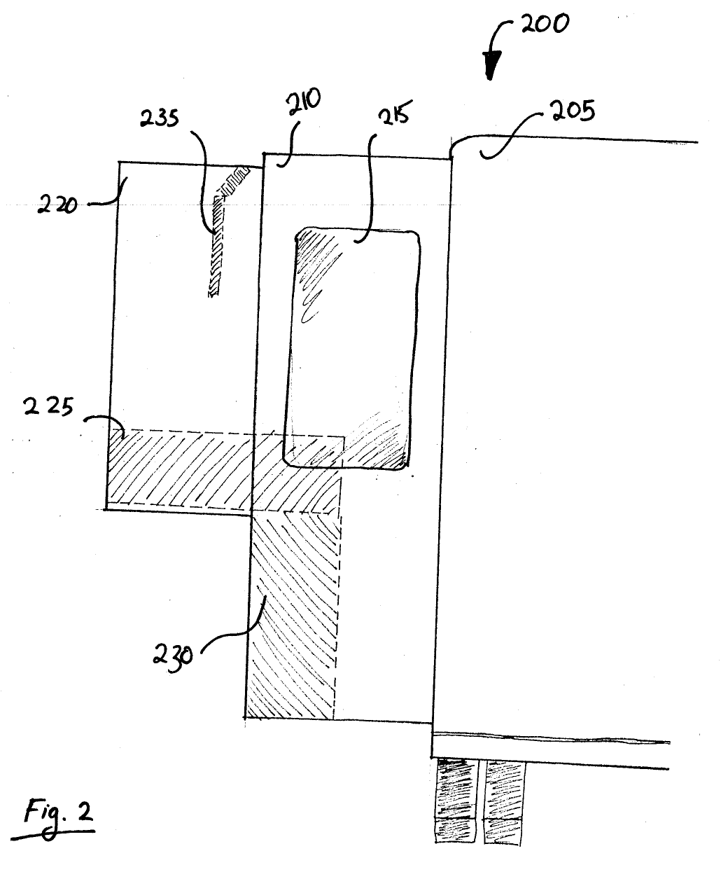

FIG. 2 is an illustration in cross-sectional view of an RV featuring one embodiment of the invention in an extended position. A motorhome body 205 is shown featuring an extendable room-in-room slide-out 200, while in an extended position. The extendable room-in-room slide-out 200 features a full-height slide-out 210 and a half-height slide-out 220. The full-height slide-out 210 features a window 215. The half-height slide-out 220 includes in its interior a desk 225, one or more cabinets 230 under the desk, and a television screen 235, which is suspended from the ceiling of the half-height slide-out 220.

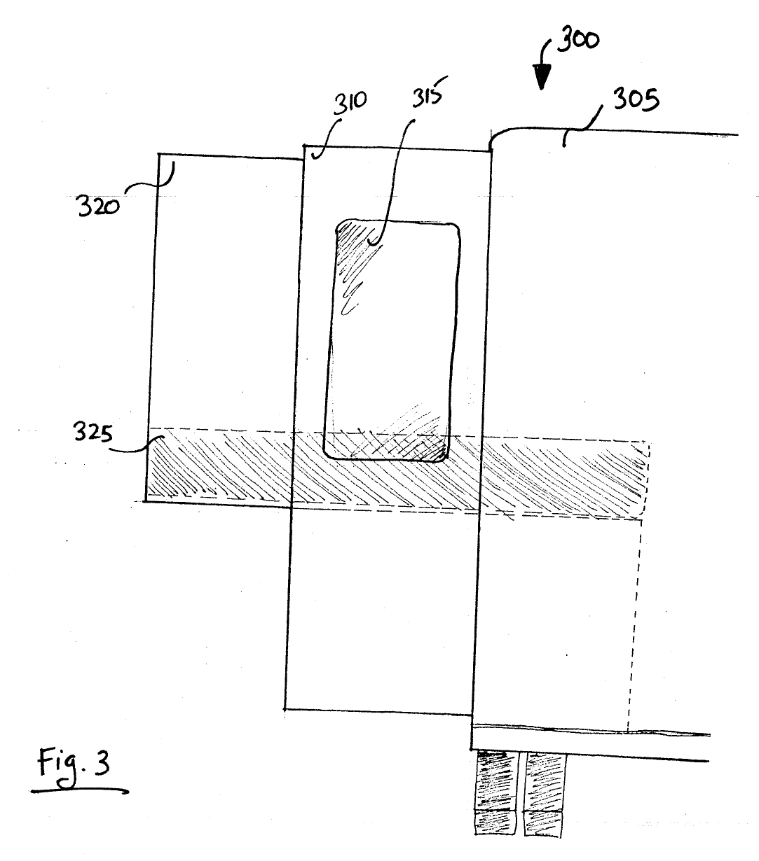

FIG. 3 is an illustration in cross-sectional view of an RV featuring one embodiment of the invention in an extended position. A motorhome body 305 is shown featuring an extendable room-in-room slide-out 300, while in an extended position. The extendable room-in-room slide-out 300 features a full-height slide-out 310 and a half-height slide-out 320. The full-height slide-out 310 features a window 315. The half-height slide-out 320 includes in its interior a bed 325.

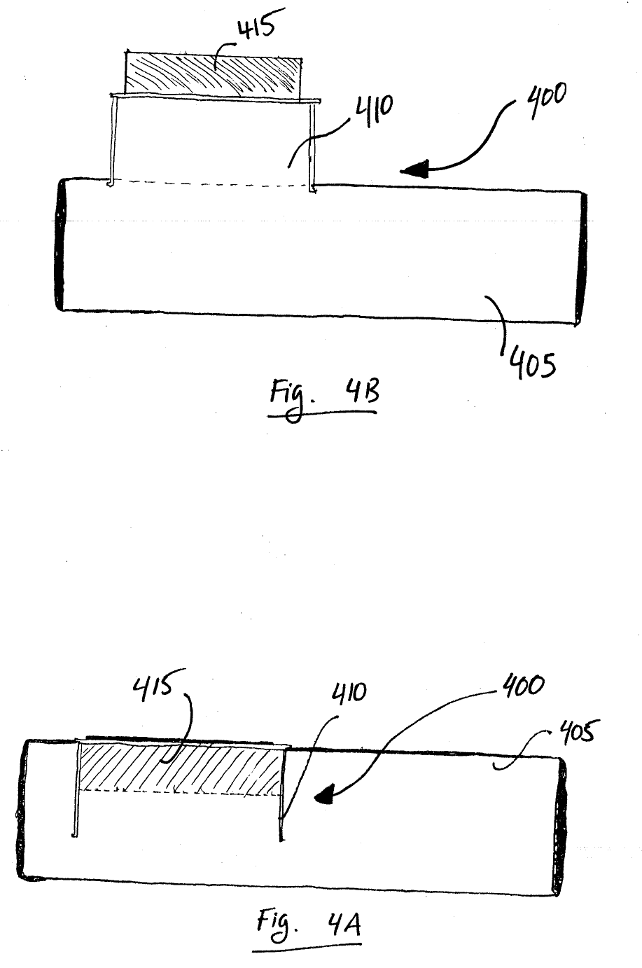

FIG. 4A is a floor-plan of an RV featuring one embodiment of the invention while contracted. A motorhome body 405 is displayed, which includes a extendable room-in-room slide-out 400. The extendable room-in-room 400 is in a contracted position and includes a full-height slide-out 410 and a half-height slide-out 415.

FIG. 4B is a floor-plan of an RV featuring one embodiment of the invention while extended. A motorhome body 405 is displayed, which includes an extendable room-in-room slide-out 400. The extendable room-in-room 400 is in an extended position and includes a full-height slide-out 410 and a half-height slide-out 415.

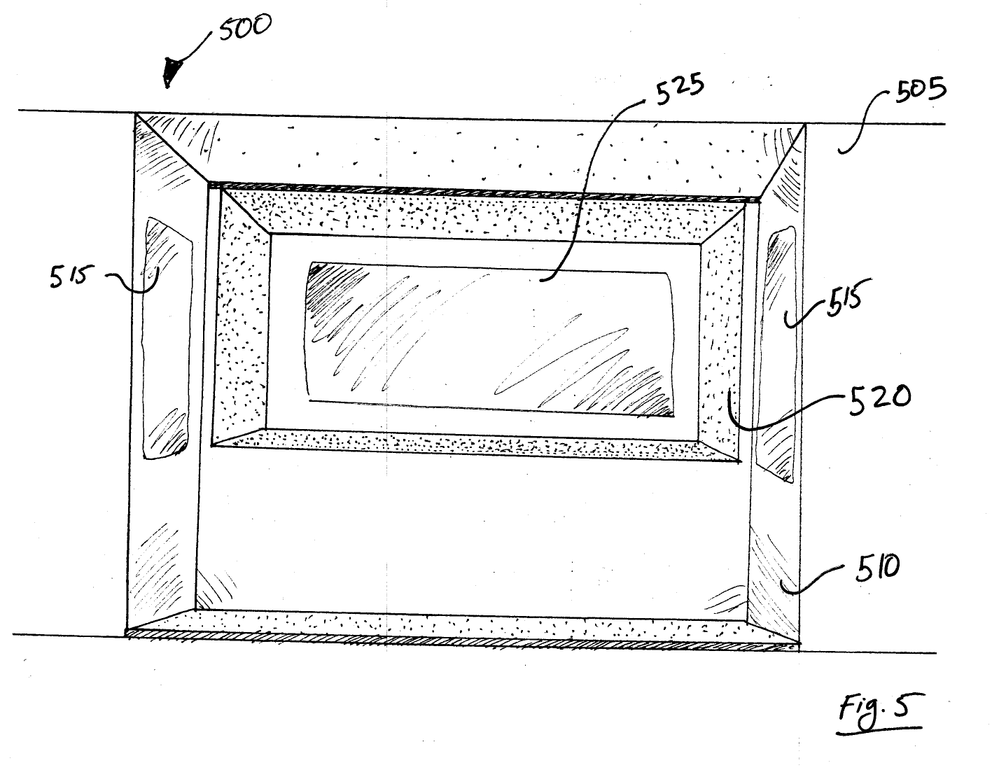

FIG. 5 is an illustration in perspective view from the interior of an RV featuring one embodiment of the invention in an extended position. A motorhome body 505 is shown featuring a an extendable room-in-room slide-out 500. The extendable room-in-room slide-out 500 features a full-height slide-out 510 and a half-height slide-out 520. The full-height slide-out 510 features a window 515 and the half-height slide-out 520 also features a window 525.

What is claimed is:

1. An extendable living space for recreational vehicles, comprising:
a first extendable slide-out room, said first extendable slide-out room being slidably attached to the chassis of said recreational vehicle,
a second extendable slide-out room, said second extendable slide-out room being slidably attached to said first extendable slide-out room and said second extendable slide-out room having a ceiling height that is less that the ceiling height of said first extendable slide-out room.

2. An extendable living space for recreational vehicles according to claim 1, wherein said second extendable slide-out room comprises a tilt-out expandable room.

3. An extendable living space for recreational vehicles according to claim 1, wherein said extendable living space includes electro-mechanical controls for deploying and retracting said extendable living space.

4. An extendable living space for recreational vehicles according to claim 1, wherein said extendable living space includes electro-pneumatic controls for deploying and retracting said extendable living space.

5. An extendable living space for recreational vehicles according to claim 1, wherein said extendable living space includes electro-hydraulic controls for deploying and retracting said extendable living space.

6. An extendable living space for recreational vehicles according to claim 1, wherein said first extendable slide-out room and said second extendable slide-out room extend horizontally outwards from the recreational vehicle walls.

7. A recreational vehicle, comprising:
a carriage assembly with a plurality of wheels,
a plurality of outer walls mounted on the carriage assembly, wherein the plurality of outer walls define a main living space having a front and rear section with a common floor,
an extendable slide-out assembly, said extendable slide-out assembly comprising a first extendable slide-out room, said first extendable slide-out room being slidably attached to the body of said recreational vehicle, and a second extendable slide-out room, said second extendable slide-out room being slidably attached to said first extendable slide-out room and said second extendable slide-out room having a ceiling height that is less that the ceiling height of said first extendable slide-out room.

8. A recreational vehicle according to claim 7, wherein said second extendable slide-out room comprises a tilt-out expandable room.

9. A recreational vehicle according to claim 7, wherein said extendable slide-out assembly includes electro-mechanical controls for deploying and retracting said extendable slide-out assembly.

10. A recreational vehicle according to claim 7, wherein said extendable slide-out assembly includes electro-pneumatic controls for deploying and retracting said extendable slide-out assembly.

11. A recreational vehicle according to claim 7, wherein said extendable slide-out assembly includes electro-hydraulic controls for deploying and retracting said extendable slide-out assembly.

12. A recreational vehicle according to claim 7, wherein said first extendable slide-out room and said second extendable slide-out room extend horizontally outwards from the recreational vehicle walls.

13. A means for expanding the living space of a recreational vehicle, comprising:
extending a first slide-out assembly from the chassis of said recreational vehicle, said first slide-out assembly being slidably attached to said recreational vehicle,
extending a second slide-out assembly from said recreational vehicle, said second slide-out assembly being slidably attached to said first slide-out assembly and having a ceiling height that is less than the ceiling height of said first slide-out assembly.

14. A means for expanding the living space of a recreational vehicle according to claim 13, wherein said second extendable slide-out assembly comprises a tilt-out expandable room.

15. A means for expanding the living space of a recreational vehicle according to claim 13, wherein said first and second extendable slide-out assemblies include electro-mechanical controls for deploying and retracting said first and second extendable slide-out assemblies.

16. A means for expanding the living space of a recreational vehicle according to claim 13, wherein said first and second extendable slide-out assemblies include electro-pneumatic controls for deploying and retracting said first and second extendable slide-out assemblies.

17. A means for expanding the living space of a recreational vehicle according to claim 13, wherein said first and second extendable slide-out assemblies include electro-hydraulic controls for deploying and retracting said first and second extendable slide-out assemblies.

18. A means for expanding the living space of a recreational vehicle according to claim 13, wherein said first extendable slide-out room and said second extendable slide-out room extend horizontally outwards from the recreational vehicle walls.
